(19) United States
(12) Patent Application Publication
(10) Pub. No.: US 2005/0235617 A1
(43) Pub. Date: Oct. 27, 2005

(54) Mist collector arrangement and methods

(76) Inventor: Brian Read, Eagan, MN (US)

Correspondence Address: MERCHANT & GOULD PC, P.O. BOX 2903, MINNEAPOLIS, MN, 55402-0903, US

(21) Appl. No.: 11/112,312

(22) Filed: Apr. 21, 2005

Related U.S. Application Data
(60) Provisional application No. 60/565,241, filed on Apr. 23, 2004.

(51) Int. Cl. B01D 46/00

(52) U.S. Cl. 55/423; 55/482

(57) ABSTRACT

A filter arrangement for a gas stream containing a mist includes a housing including an inlet, an interior, and an outlet arrangement; the inlet being oriented to receive a gas stream containing a mist; a pre-filter arrangement oriented to receive the gas stream containing the mist from the inlet; the pre-filter arrangement removing at least some particulate material from the gas stream and at least partially coalescing the mist into a liquid; at least one tubular primary filter element having at least one region of filter media and an open filter interior; the tubular primary filter element being operably oriented in the housing interior downstream of the pre-filter arrangement and oriented to receive flow of the gas stream into the open filter interior then through the at least one region of filter media and then exit the housing through the outlet arrangement; the tubular primary filter element at least partially coalescing the mist into liquid; and a liquid sump arrangement oriented in the housing constructed and arranged to collect liquid removed by the pre-filter arrangement and the primary filter element. Filter elements usable in the system, methods of servicing, and methods of filtering are provided.

### CROSS REFERENCE TO RELATED APPLICATIONS

This application claims priority under 35 U.S.C. § 119(e) to provisional patent application Ser. No. 60/565,241 filed Apr. 23, 2004. The complete disclosure of application 60/565,241 is incorporated herein by reference.

### TECHNICAL FIELD

This application relates to mist collector systems, filter elements, and methods.

### BACKGROUND

The metal working industry utilizes various coolants and lubricants during cutting and forming operations. These liquids include pure oils, oil and water mixtures, and non-oil synthetics. Because of the forces with which these fluids are applied during metal working operations and the heat generated when the cutting tool meets the work piece, a fine mist or aerosol (airborne) is often generated. To arrest this mist, a filter system is required.

If the machine tool is freestanding, the aerosol mist can be pulled away from the area using a hood over the cutting area. Alternatively, newer machine tools employ enclosures around the cutting areas, which allow the mist to be withdrawn from a single location.

Certain mist collector constructions and cartridges are described in U.S. Pat. Nos. 5,454,858; 5,415,676; 5,611,922; and 6,007,608, the disclosures of each of these patents being incorporated herein by reference. Each of these patents is owned by Donaldson Company, Inc., the Assignee of the present application.

### SUMMARY

A filter arrangement for a gas stream containing a mist includes a housing including an inlet, an interior, and an outlet arrangement; the inlet being oriented to receive a gas stream containing a mist; a pre-filter arrangement oriented to receive the gas stream containing the mist from the inlet; the pre-filter arrangement removing at least some particulate material from the gas stream and at least partially coalescing the mist into a liquid; at least one tubular primary filter element having at least one region of filter media and an open filter interior; the tubular primary filter element being operably oriented in the housing interior downstream of the pre-filter arrangement and oriented to receive flow of the gas stream into the open filter interior then through the at least one region of filter media and then exit the housing through the outlet arrangement; the tubular primary filter element at least partially coalescing the mist into liquid; and a liquid sump arrangement oriented in the housing constructed and arranged to collect liquid removed by the pre-filter arrangement and the primary filter element.

A filter element comprises first and second end caps; an inner tubular region of filter media extending between the first and second end caps; an outer filter support circumscribing the inner tubular region of filter media and extending from the second end cap toward the first end cap; the outer filter support defining a filter seat at a location spaced from at least the second end cap; and an outer tubular region of filter media being positioned in the filter seat; the outer tubular region of media being radially spaced from the inner tubular region of filter media by a gap of at least 0.12 inch.

A filter element comprises first and second opposite ends defining a length therebetween; a first open end cap at the first end; the first end cap defining a first inwardly directed radial sealing portion; the first inwardly directed radial sealing portion defining a first end cap inner diameter; a second end cap at the second end; the second end cap defining a second inwardly directed radial sealing portion; the second inwardly directed radial sealing portion defining a second end cap inner diameter; the second end cap inner diameter being smaller than the first end cap inner diameter; a cylindrical region of pleated media extending between the first and second end caps; the cylindrical region having an inner diameter; and a ratio of the inner diameter to the length is not greater than 0.3.

A method of servicing a filter arrangement includes accessing an interior to a housing; removing a first filter element from the housing; providing a second filter element; tilting the second filter element relative to the housing while placing the second filter element in the interior of the housing; while tilting, orienting a top end cap of the second filter element around an inlet flow tube in the housing to form a first radial seal between the second filter element and the inlet flow tube; and straightening the second filter element while moving the second filter element down to form a second radial seal between a second end cap in the second filter element and a portion of the housing.

A method of filtering a gas stream containing a mist; the method comprises directing a gas stream containing mist into an inlet of a housing and through pre-filter arrangement to remove some particulate material and coalesce at least some of the mist into liquid; directing the gas stream from the pre-filter arrangement and into an interior of a primary filter; directing the gas stream from the primary filter interior and through at least one region of media to result in a filtered fluid; the at least one region of media coalescing the mist into liquid; directing the filtered fluid out of the housing; draining liquid from the pre-filter arrangement past the primary filter to a sump; and draining liquid from the primary filter to the sump.

A filter arrangement for a gas stream containing a mist includes a housing including an inlet, an interior, and an outlet arrangement; the inlet being oriented to receive a gas stream containing a mist; a pre-filter arrangement oriented to receive the gas stream containing the mist from the inlet; the pre-filter arrangement removing at least some particulate material from the gas stream and at least partially coalescing the mist into a liquid; at least one primary filter element operably oriented in the housing interior downstream of the pre-filter arrangement and oriented to receive flow of the gas stream to at least partially coalescing the mist into liquid; a liquid sump arrangement oriented in the housing constructed and arranged to collect liquid removed by the pre-filter arrangement and the primary filter element; and a pre-filter drain arrangement constructed and arranged to convey liquid from the pre-filter arrangement to the liquid sump arrangement while bypassing the at least one primary filter element.

A method of filtering a gas stream containing a mist includes directing a gas stream containing mist into an inlet of a housing and through pre-filter arrangement to remove some particulate material and coalesce at least some of the mist into liquid; and then directing the gas stream in a direction downwardly from the prefilter arrangement and downwardly to a primary filter; directing the gas stream through at least one region of media in the primary filter to result in a filtered fluid; the at least one region of media coalescing the mist into liquid; directing the filtered fluid out of the housing; and draining liquid from the pre-filter arrangement and the primary filter.

### BRIEF DESCRIPTION OF THE DRAWINGS

FIG. 1 is a perspective view of a filter arrangement constructed according to principles of this disclosure;

FIG. 2 is an exploded, perspective view of the filter arrangement of FIG. 1;

FIG. 3 is a schematic, cross-sectional view depicting fluid flow through the filter arrangement of FIG. 1;

FIG. 4 is a side elevational view of a primary element utilized in the arrangement depicted in FIGS. 1-3;

FIG. 5 is a bottom plan view of the primary filter element depicted in FIG. 4;

FIG. 6 is a schematic, cross-sectional view of the primary filter element depicted in FIG. 5, the cross-section being taken along the line 6-6 of FIG. 5;

FIG. 7 is a cross-sectional view of the pre-filter utilized in the filter arrangement of FIGS. 1-3;

FIG. 8 is a top plan view of a portion of the sump arrangement depicted in FIGS. 1-3; and

FIG. 9 is a schematic, cross-sectional view of the sump arrangement depicted in FIG. 8, the cross-section being taken along the line 9 ! 9 of FIG. 8.

### DETAILED DESCRIPTION

A. Overview of System

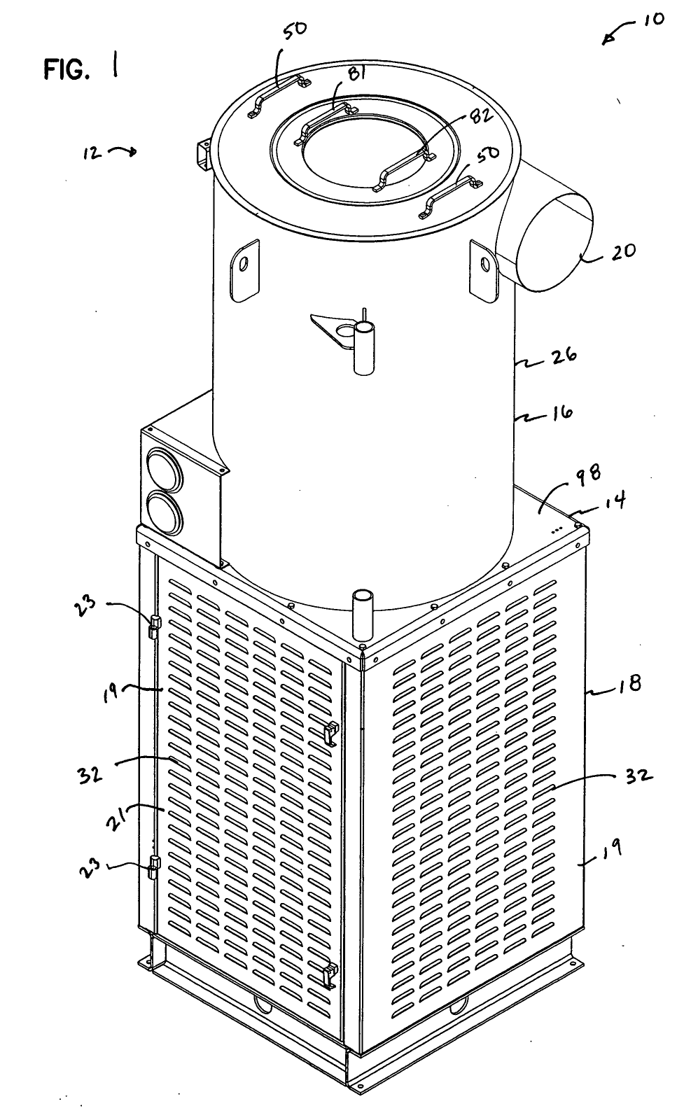

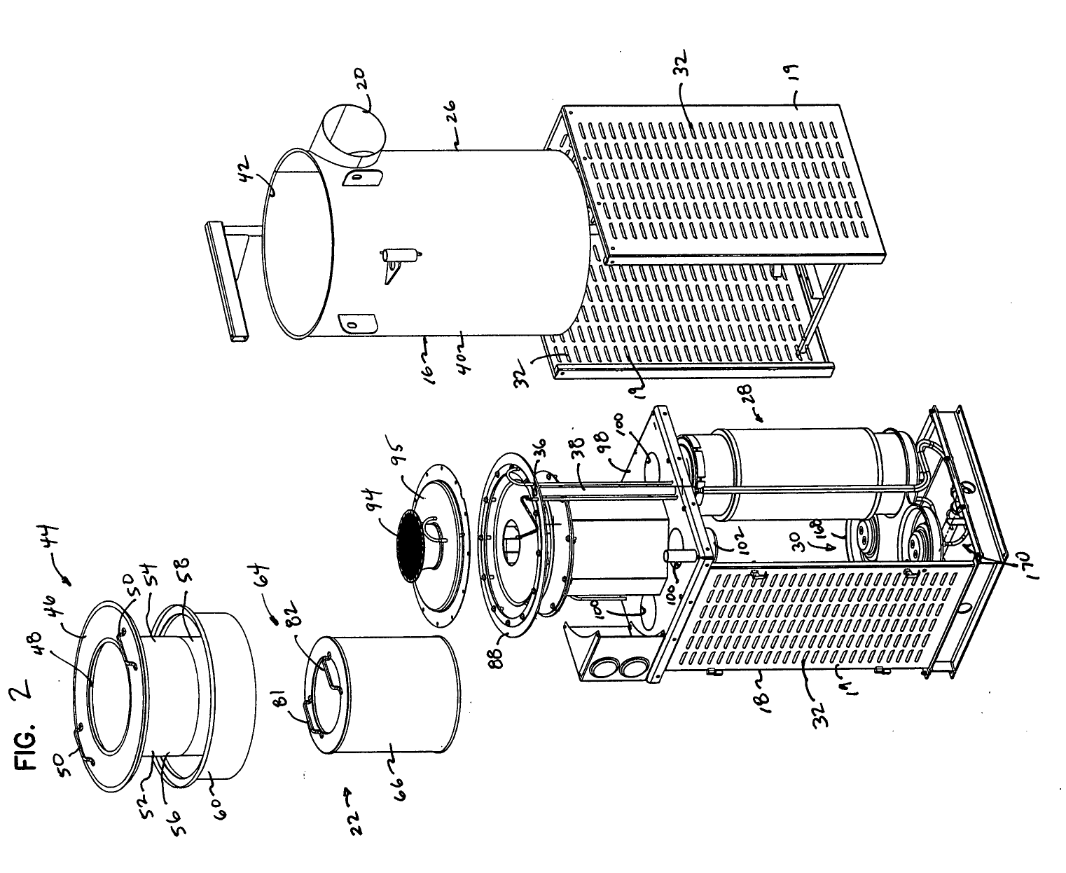

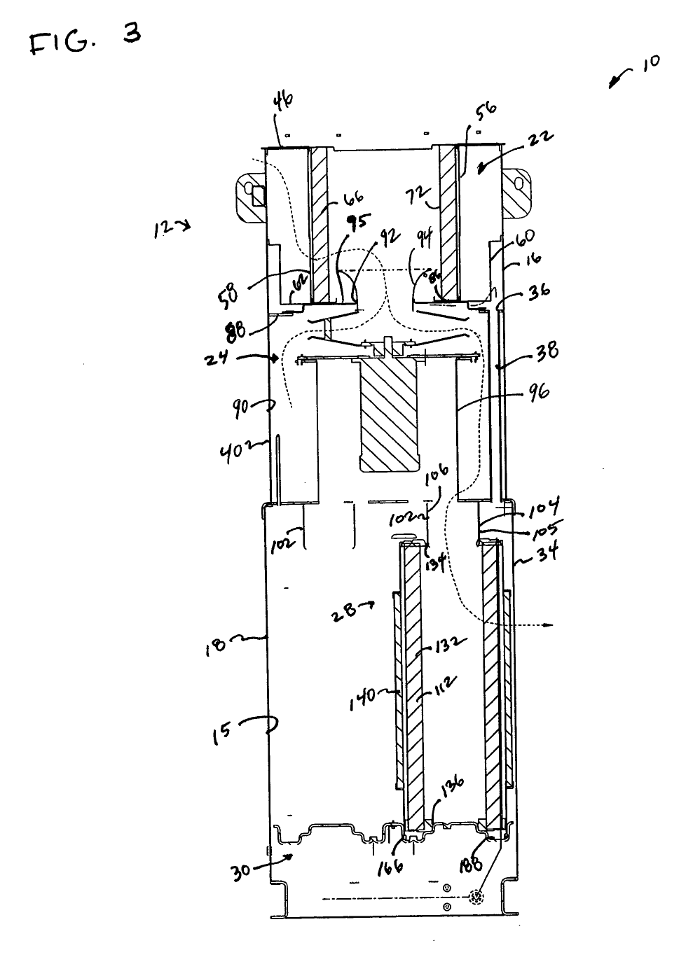

FIG. 1 illustrates a mist collection system generally at 10. The mist collection system 10 that is depicted in FIG. 1 is embodied as a filter arrangement 12. The mist collection system 10 includes a housing 14 with an upper chamber 16 and a lower chamber 18. The upper chamber 16 defines an inlet 20 and further houses or contains a pre-filter arrangement 22 (FIG. 2). The upper chamber 16 also holds a blower or fan arrangement 24 (FIG. 3). As can be seen in FIG. 1, the inlet 20 is arranged relative to the sidewall 26 in a tangential relationship. Because of the tangential relationship between the inlet 20 and the sidewall 26, fluid flowing through the inlet 20 will swirl around in the pre-filter arrangement 22 in a centrifugal fashion, to help cause particulate matter and liquid in the fluid to drop by gravity downwardly rather than flow through the media of the pre-filter arrangement.

The lower chamber 18 houses or contains a primary filter arrangement 28 (FIG. 2). Located vertically below and under the primary filter arrangement 28 is a sump arrangement 30 (FIG. 2). The sump arrangement 30 collects and drains off liquid that is removed from the mist. The lower chamber 18 includes, in the embodiment shown, a plurality of doors 19 defining the lower chamber 18. At least one of the doors 21 can be pivotally mounted on hinges 23 to allow selective access to an interior 15 (FIG. 3) of the lower chamber 18.

FIG. 3 illustrates schematically operation of the mist collection system 10. A fluid stream comprising a gaseous stream with liquid droplets and particulate, or a gaseous stream with mist, flows into the filter arrangement 12 through the inlet 20 (FIGS. 1 and 2). The fluid then flows through the pre-filter arrangement 22 that provides an initial coalescing of liquid from the fluid stream and an initial filtration of particulate matter. The fluid then flows into an interior of a pre-filter element 64, and is then pulled by the fan arrangement 24 past the fan arrangement 24 and into the lower chamber 18. From there, the fluid flows into an interior of the primary filter arrangement 28, through the filter media of the primary filter arrangement 28, and exits the housing through an outlet arrangement 32 in a sidewall 34 of the lower chamber 18 of the housing 14. The liquid collected by the pre-filter arrangement 22 is collected in a drain 36 (FIG. 2) and conveyed through tubing 38 past the fan arrangement 24, past the primary filter arrangement 28, and to the sump 30. Liquid that is coalesced by the primary filter arrangement 28 drips by gravity from the primary filter arrangement 28 into the sump arrangement 30.

B. The Example Embodiment of FIGS. 1-9

With the above overview in mind, we now turn to details of an example embodiment illustrated in FIGS. 1-9. It should be understood that the embodiment illustrated in FIGS. 1-9 is only one example, and many variations can be constructed in accordance with principles of this disclosure.

In general, the housing 14 is constructed of sheet metal. The upper chamber 16 is a generally cylindrical body 40 having the tangential inlet 20 and houses the pre-filter arrangement 22. The pre-filter arrangement 22 functions to initially remove some liquid and some particulate from the fluid stream entering the inlet 20. In the illustrated embodiment, the pre-filter arrangement 22 comprises the tangential inlet 20, a swarf basket 44 and a pre-filter element 64.

In the embodiment shown, the body 40 has an open end 42 (FIG. 2) that operably receives the swarf basket 44. The swarf basket 44 is provided to help remove particulate material from the fluid. In reference to FIG. 2, the basket 44 includes a top plate 46 defining an opening 48 to fit around (circumscribe) the pre-filter element 64. The top plate 46 has a pair of handles 50 extending axially from the plate 46. In this way, the basket 44 can be selectively removed from the upper chamber 16 of the housing 14.

Connected to the plate 46 is a surrounding wall 52. The wall 52 has a pair of sections. The section 54 immediately adjacent to the plate 46 is a solid shield 56. This shield 56 blocks mist from flowing directly from the tangential inlet 20 straight into the pre-filter arrangement 22. Instead, the shield 56 helps to induce centrifugal flow around the shield 56, between the shield 56 and the sidewall 26 of the body 40. This centrifugal flow helps to cause particulate matter to drop by gravity out of the fluid stream. Located next to the section 54 is a porous inner liner 58. The inner liner 58 allows the fluid stream to flow through the inner liner 58 and to the pre-filter element 64. Spaced from the inner liner 58 and generally parallel thereto is an outer liner 60. The inner liner 58 and outer liner 60 can be constructed from porous materials, such as expanded metal, or perforated metal or plastic. Connecting the inner liner 58 and outer liner 60 is a base disc 62 (FIG. 3). The base disc 62 defines drain apertures to allow for the drainage of liquid coalesced by the pre-filter arrangement 22.

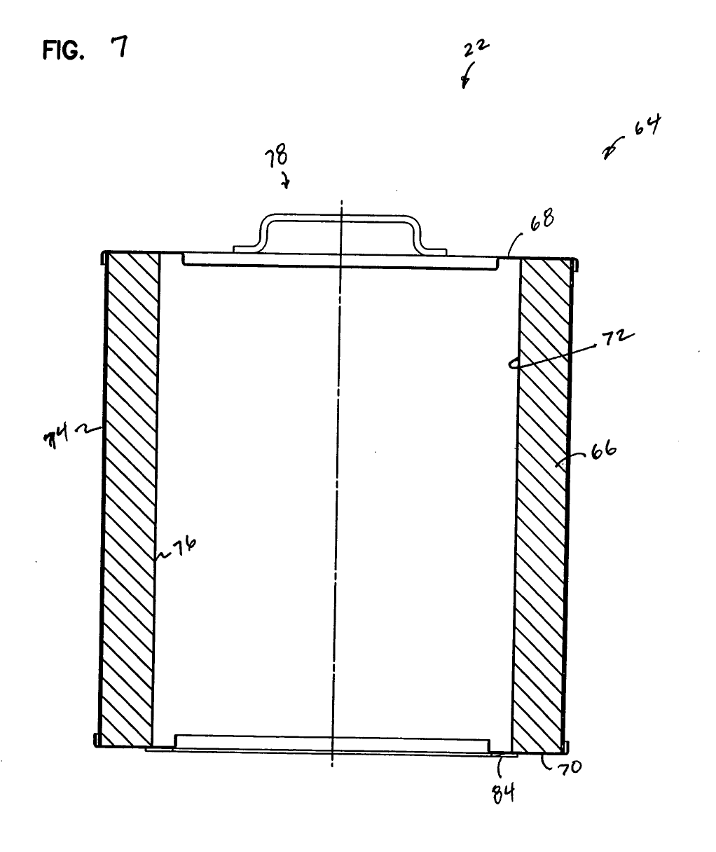

As mentioned above, the opening 48 in the swarf basket 44 is sized to fit over/around the pre-filter element 64. As embodied herein, the pre-filter element 64 has a cylindrical arrangement of filter media 66. In reference now to FIG. 7, the filter element 64 for the pre-filter arrangement 22 has a first, closed end cap 68 at one end of the filter element 64. At an opposite end of the filter element 64 is an open end cap 70. The end caps 68, 70 can be metal end caps, or molded plastic end caps. The filter media 66 extends between and is secured to the closed end cap 68 and open end cap 70. The filter media 66 forms a cylinder defining an open pre-filter interior 72.

Still in reference to FIG. 7, the particular filter element 64 illustrated further includes an outer filter support or liner 74 and an inner filter support or liner 76. The outer liner 74 and inner liner 76 help to support the filter media 66 to prevent it from collapsing.

The filter element 64 includes a handle arrangement 78 to help manipulate the filter element 64. In the embodiment illustrated, the handle arrangement 78 includes first and second handle members 81, 82 (FIG. 2) axially extending from the closed end cap 68.

The filter media 66 may be made of many different materials including felt or polyester or wire mesh. One useable material for the media 66 includes an uncorrugated, polyester fiber having a weight of 10 oz/yd² (339 g/m²); a thickness at 0.002 psi of 0.185+/−0.025 in. (4.7+/−0.64 mm); and a Frazier permeability of about 450 ft/min (137 m/min).

Extending from the open end cap 70 is an axial seal member 84. The axial seal member 84 forms an axial seal 86 (FIG. 3) with a plate 95, discussed below.

In reference again to FIG. 3, the upper chamber 16 has a flange 88 extending radially from an inner surface 90 of the body 40 of the upper chamber 16. The flange 88 collects coalesced liquid that is drained through the base disc 62 and allows it to drain by gravity through the drain 36 (FIGS. 2 and 3) and down through the tubing 38. From the tubing 38, the collected liquid is directed to the sump arrangement 30.

A flow tube 94 mounted within a plate 95 (FIGS. 2 and 3) is supported by the flange 88. The plate 95 has an aperture 92, in which the flow tube 94 projects through. The flow tube 94 helps to convey the mist that has initially gone through the filter media 66 of the filter element 64 from the pre-filter interior 72 down to the primary filter arrangement 28. Specifically, the fan arrangement 24 includes a blower housing 96 (FIG. 3), which draws the fluid mist from the pre-filter interior 72 through the flow tube 94. From the flow tube 94, the fluid fluid/mist is conveyed around and past the blower housing 96 and then pushed into the lower chamber 18.

In reference now to FIG. 2, the filter housing 14 includes a tube sheet 98 that divides the upper chamber 16 from the lower chamber 18. The tube sheet 98 defines at least one, in some cases at least two, and in the embodiment illustrated, four openings 100. Each of the openings 100 has an inlet tube 102 (FIG. 3) axially extending therefrom. Each of the inlet tubes 102 comprises a cylindrical wall 104 having an outer surface 105 and defines a tubular interior 106. A fluid mist that is conveyed from the pre-filter interior 72 past the blower housing 96 is pushed through the tubular interior 106 to reach the primary filter arrangement 28. Preferably, there is at least one primary filter arrangement 28. More preferably, there are least two primary filter arrangements 28. In the embodiment illustrated, there are four primary filter arrangements 28 provided.

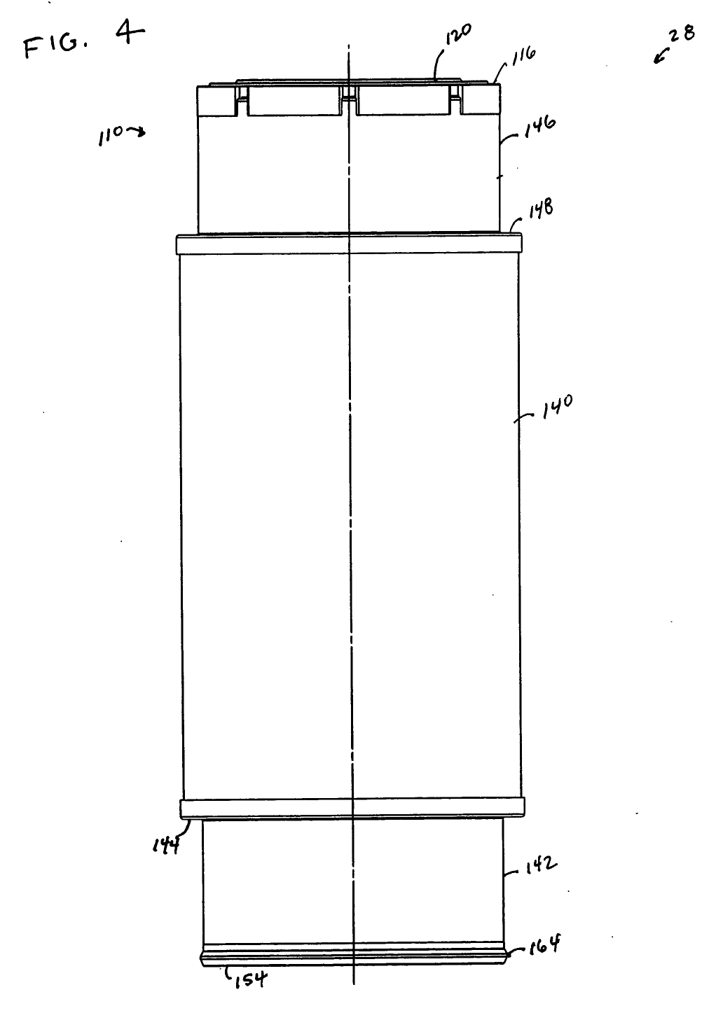

In reference now to FIGS. 4-6, an example embodiment of the primary filter arrangement 28 is illustrated. The primary filter arrangement 28 illustrated includes a cylindrical primary filter element 110. The primary filter element 110 has at least one region of filter media 112 and an open filter interior 114. The primary filter element 110 is operably oriented in the housing 14 downstream of the fan arrangement 24 and is oriented to receive mist flow into the open filter interior 114, then through the at least one region of filter media 112, and then exit the housing 14 through the outlet arrangement 32 (FIGS. 1-3). In the embodiment illustrated, the filter element includes a first end 116, a second end 118, and defines a length between the first end 116 and second end 118. There is a first open end cap 120 at the first end 116. In the embodiment shown, the first end cap 120 defines a first inwardly directed radial sealing portion 122. The first inwardly directed radial sealing portion 122 defines a first end cap inner diameter. The radial sealing portion 122 can be molded as part of the end cap 120. In certain embodiments, the end cap 120 will be molded from a compressible polyurethane foam to result in the sealing portion 122. The sealing portion 122 can have a stepped construction 124 and can be made generally in accordance with the radial seal described in U.S. Pat. No. 5,938,804, which is incorporated herein by reference.

At the second end 118 is a second open end cap 126 defining a second inwardly directed radial sealing portion 128. The second inwardly directed radial sealing portion 128 defines a second end cap inner diameter. The second radial sealing portion 128 can also be constructed from a compressible polyurethane foam and have a stepped construction 130. It can be made the same way as the first radial sealing portion 122, but preferably defining a smaller inner diameter. By having a smaller inner diameter at the second end cap 126, the user will install the element 110 in the correct orientation, to permit drainage of coalesced liquid to the second end 118. In preferred embodiments, a ratio of the second end cap inner diameter to the first end cap inner diameter is at least 0.15, for example, between 0.5 and 0.9, and no greater than 0.95.

The filter media 112 extends between the first end cap 120 and the second end cap 126. Preferably, the filter media 112 includes pleated media 132. Various types of media 112 can be used. One usable type of media is the following: a polypropylene meltblown air filter medium with a basis weight of about 5.6 oz/yd² (190 gm/m²); thickness at 0.002 psi of about 0.118 in. (3.0 mm); and a permeability of about 25 ft/min (7.6 m/min). Usable pleated media 132 will have a pleat depth of 1.4-2 in., typically about 1.8-1.9 in.

It has been found that the arrangement is particularly useful if a ratio of the inner diameter of the filter media 112 to the length of the element between the first end 116 and the second end 118 is controlled to be not greater than 0.3, better performance is achieved. This is because the smaller the ratio is, the smaller the area of wet band is. By “wet band”, it is meant a band of media 112 adjacent to the second end 118 that becomes wet, sometimes saturated, due to the draining of coalesced liquid from the element 110. Typical ratios of the inner diameter of the filter media 112 to the length of the element 110 are between 0.05 and 0.25, for example, 0.15 and 0.2. Preferably, the element 110 will have an overall length of at least 28 inches, more preferably at least 32 inches, for example, 34-40 inches. Useful inner diameters of the filter media 112 will be not greater than 10 inches, preferably not greater than 8 inches, for example 5-7 inches.

In the embodiment shown, the filter element 110 further includes an outer liner 138 extending between the first end cap 120 and the second end cap 126.

In reference now to FIG. 3, the first radial sealing portion 122 compresses against the outer surface 105 of the inlet tube 102 to form a first radial seal 134 between and against the filter media 112 and the outer surface 105 of the inlet tube 102. Still in reference to FIG. 3, the second radial sealing portion 128 compresses between and against the filter media 112 and a portion of the sump arrangement 30 to form a second radial seal 136.

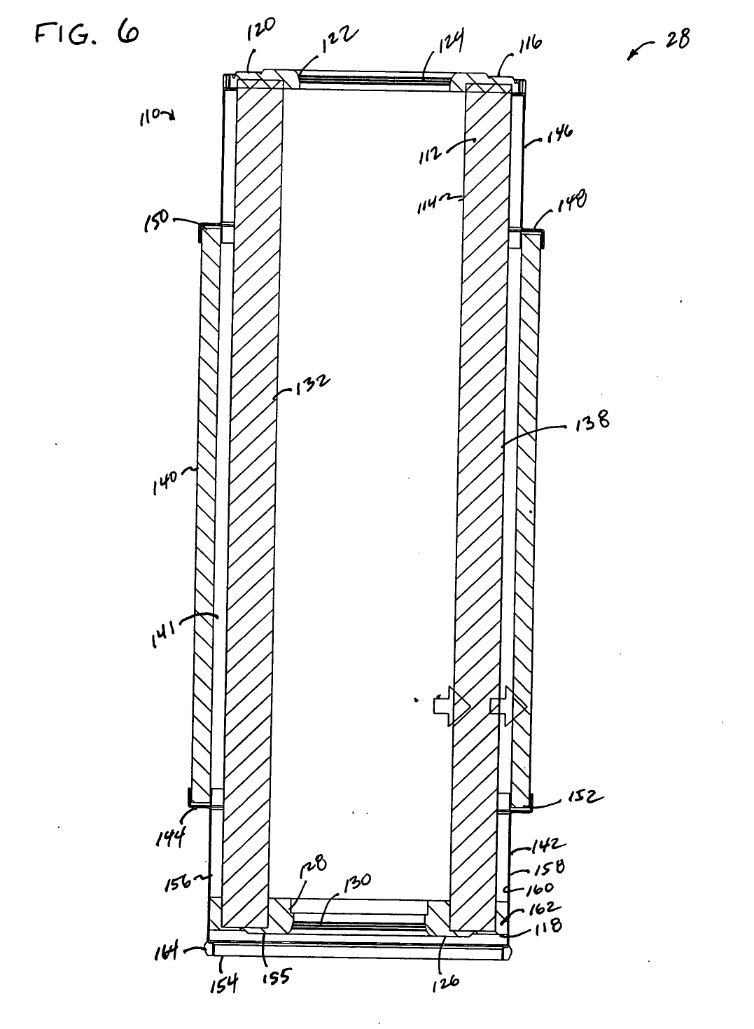

In some embodiments, the primary filter element 110 includes only the first region of filter media 112. In other embodiments, including the embodiment illustrated in FIGS. 4-6, the filter element 110 includes an outer tubular region of filter media 140. In preferred embodiments, the outer region of filter media 140 is a high efficiency particulate air (HEPA) or a 95% DOP media that circumscribes the inner filter region 112. As can be seen in FIG. 6, in the embodiment shown, the outer region of filter media 140 is spaced from the inner region of filter media 112 by a gap 141 sufficiently large to prevent the outer region of media 140 from becoming wet. The gap 141 is to allow for the drainage of coalesced liquid off of the first stage media 112. The gap 141 is at least 0.12 inch, and typically 0.3-0.5 inch.

Preferably, the outer region of media 140 is spaced from the second end 118 to avoid having the outer region of media 140 adjacent to the sump arrangement 30. This is to avoid having the outer region of media 140 become wet because it would result in very high restriction if becoming wet. Of course, in some arrangements, the outer region of media 140 could extend the entire length of the inner region of media 112, but having it spaced from the bottom end cap 126 is preferred. In the illustrated embodiment, to space the outer region of media 140 from the second end 118, the filter element 110 includes an outer filter support 142 circumscribing the inner tubular region of filter media 112 and extending from the second end cap 126 in a direction toward the first end cap 120. The outer filter support 142 defines a filter seat 144 at a location spaced from both the first end cap 120 and the second open end cap 126. The outer region of filter media 140 is positioned within the filter seat 144.

In some embodiments, it may be useful to extend the outer region of media 140 to the first end cap 120. In the illustrated embodiment, however, the outer region of media 140 is spaced from the first end cap 120. In particular, there is an outer filter support 146 extending from the first end cap 120 in a direction toward the second end cap 126 defining a filter seat 148 at a location spaced from both the first end cap 120 and the second end cap 126. The outer region of filter media 140 is oriented within the filter seat 148. In this manner, in the embodiment shown, the outer region of filter media 140 is located spaced from both the first end cap 120 and the second end cap 126. In example embodiments, a first end 150 of the outer region of filter media 140 is spaced at least 0.5 in., typically about 2-8 in. from the first end cap 120, while a second end 152 of the outer region of filter media 140 is spaced from the second end cap 126 by a distance of at least 2 in., typically 5-10 in., for example, about 6 in.

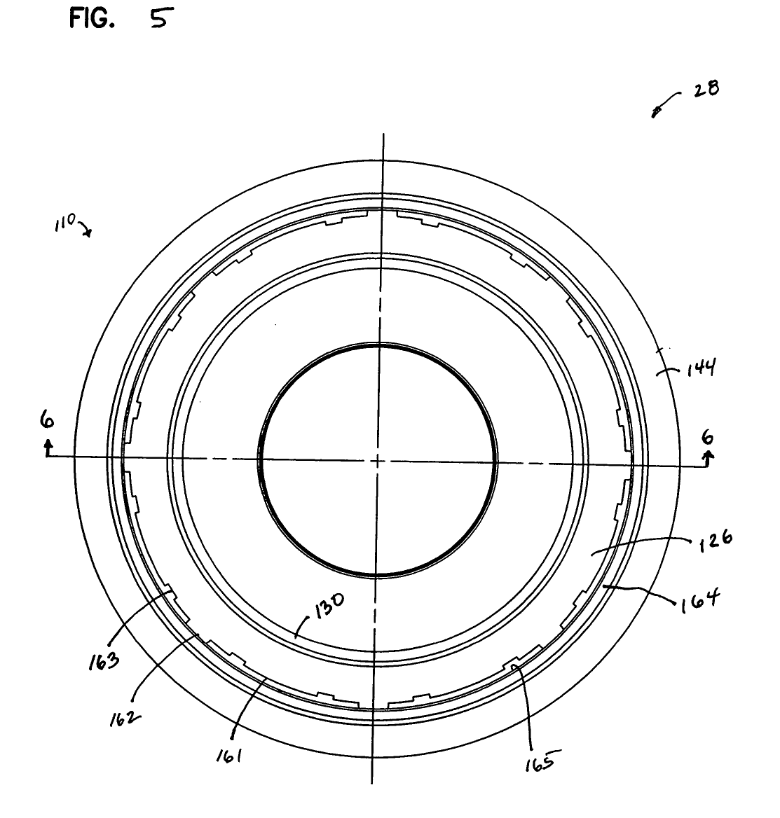

In the embodiment illustrated, the outer filter support 142 has an end 154 opposite of the end defining the filter seat 144. The end 154 extends past an axial end 155 of the second open end cap 126. The outer filter support 142 includes a cylindrical wall 156 with an outer surface 158 and an inner surface 160. In reference to FIG. 5, the second end cap 126 has an outer perimeter 161 of outwardly spaced projections 162 and inwardly extending recesses 163. The outerwardly spaced projections 162 are radially compressed against the inner surface 160 of the wall 156. The inwardly extending recesses 163 form a drainage channel 165 between the outer perimeter 161 of the end cap 126 and the inner surface 160 of the wall 156. Liquid that coalesces on the inner region of media 112 can drain down along the outside of the media 112 in the gap 141 and then through the drainage channel 165.

Adjacent to the end 154 of the outer filter support 142, another radial seal member 164 extends radially outwardly from the outer surface 158 of the wall 156. The radial seal member 164 forms a radial seal 166 (FIG. 3) between and against the outer surface 158 of the outer filter support 142 and a portion of the sump arrangement 30.

Turning now to FIGS. 2, 8 and 9, one embodiment of a sump arrangement is illustrated at 30. The particular sump arrangement 30 shown in the drawings includes a sump tube sheet 168 and a liquid collection arrangement 170 (FIG. 2). The liquid collection arrangement 170 includes an arrangement of tubes that collect and drain away the liquid collected in the sump tube sheet 168 and from the drain 36 and tubing 38 from the pre-filter arrangement 22.

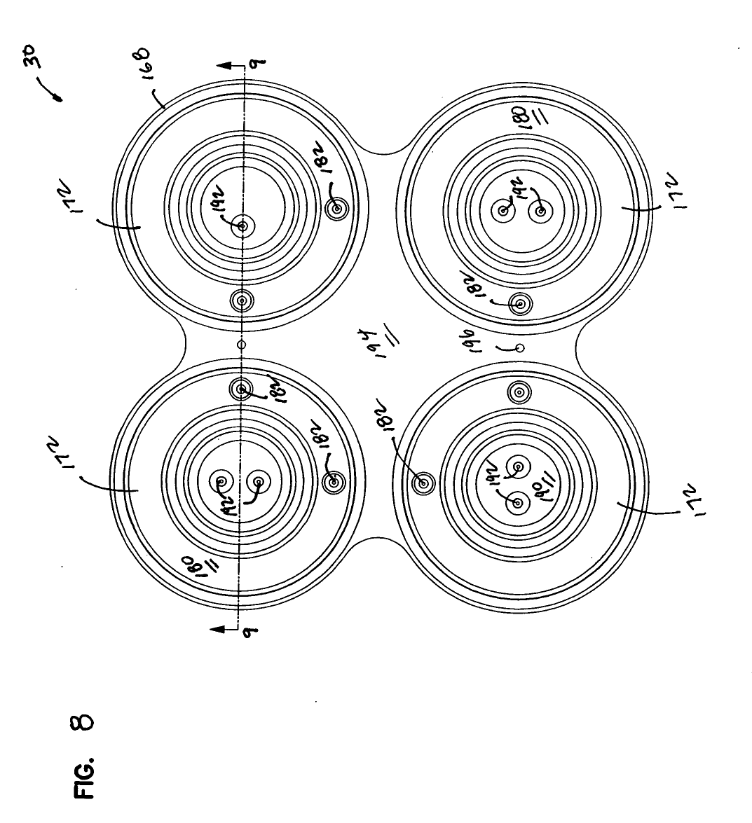

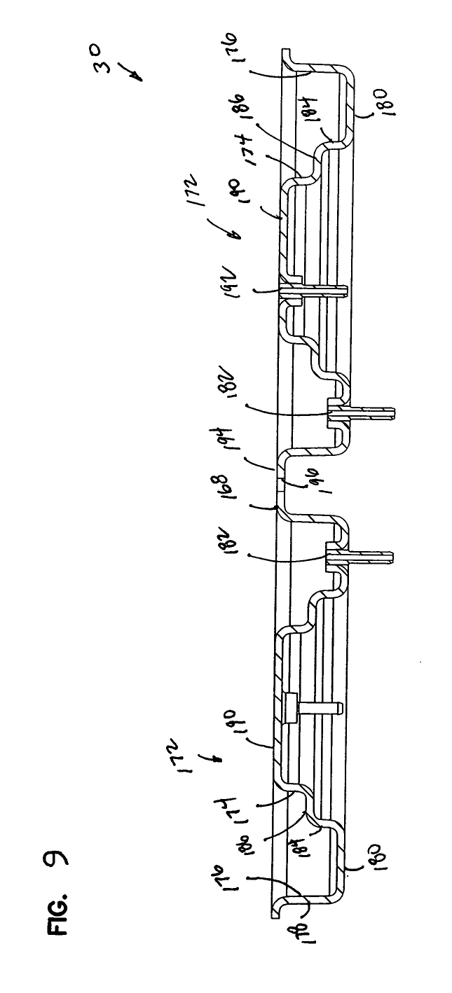

The sump tube sheet 168 is constructed and arranged to hold the primary filter elements 110. In the embodiment shown in FIG. 8, the sump tube sheet 168 includes at least one, preferably at least two, and as illustrated, four primary filter seats 172. In reference now to FIG. 9, a cross-section of the sump tube sheet 168 is illustrated. Two of the primary filter element seats 172 are shown in cross-section. Each primary filter seat 172 is constructed and arranged to receive the primary filter elements 110 and form the second radial seal 136 (FIG. 3) with the primary filter element 110.

In particular, each filter seal 172 includes a sealing surface 174 in which the radial sealing portion 128 of the primary element 110 is compressed against to form the radial seal 136. When the primary element 110 includes only the first region of filter media 112, then the only seal formed between the sump tube sheet 168 and the filter element 110 would be the seal 136, although more seals could be used if desired. When the filter element 110 also includes the outer region of filter media 140, then the sump tube sheet 168 also accommodates the seal member 164 (FIG. 6) to form radial seal 166 (FIG. 3). The radial seal 166 is formed against the sealing surface 176.

In reference now to FIG. 9, a profile of one of the primary filter element seats 172 is depicted. Many arrangements are useable. In the particular embodiment shown, each of the primary filter element seats 172 is generally circular, when viewed from the top (FIG. 8). The outer most vertical wall 178 forms the sealing surface 176. Generally orthogonal to the wall 78 is a base 180. The base 180 defines aperture drain holes 182 to drain liquid collected on the base 180 into the liquid collection arrangement 170. Orthogonal to the base 180 and generally parallel to and spaced from the wall 178 is a wall 184. Adjacent to the wall 184 and parallel to and spaced from the base 180 is a horizontal wall 186. The horizontal wall 186 provides for a resting surface of the end of the filter element 110. In this way, there is an open space or gap 188 (FIG. 3) between the end 154 of the filter element 110 and the sump tube sheet 168. This gap 188 allows for liquid to be collected and drain into the liquid collection arrangement 170 without requiring the media 112 in the filter element 110 to stand in the collected liquid. If it were required to stand in the collected liquid, this would cause that portion of the media 112 resting in the collected liquid to have a high restriction and limited filtering capability.

Adjacent to the horizontal wall 186 and parallel to and spaced from wall 178 and wall 184 is the sealing surface 174. Adjacent to the sealing surface 174 is a horizontal wall 190. The horizontal wall 190 defines drain holes 192 that drain liquid collected along the horizontal wall 190 to the liquid collection arrangement 170.

The filter seats 172 are joined together by section 194. Section 194 defines drain holes 196 that drain any collected liquid to the liquid collection arrangement 170.

C. Methods

A method of servicing a mist collector system, such as system 10 is provided. The method of servicing includes servicing a filter arrangement, such as filter arrangement 12 illustrated in FIG. 1. First, an interior 15 of the housing 14 is accessed. This can be done by pivoting the door 21 about its hinges 23 to access the interior 15. This step exposes the plurality of filter elements 110 located within the interior 15.

Next, one of the filter elements 110 is removed from the housing 14. This is done by sliding the filter element 110 vertically upwardly along the inlet tube 102 to, first, release the radial seal 136 and if present, the radial seal 166. Next, the filter element 110 is angled or tilted such that the bottom end 154 of the filter element 110 is swung upwardly and out of the seat 172 of the sump tube sheet 168. Next, the filter element 110 is slid downwardly relative to the inlet tube 102 to remove the filter element 110 from the inlet tube 102 and release the radial seal 134. The filter element 110 is then removed from the housing 14 and is incinerated or otherwise disposed.

Next, a new filter element 110 is provided. The second, new filter element is oriented in the interior 15 of the housing 14. The filter element 110 is tilted relative to the housing 14 while orienting the first open end cap 110 around the inlet flow tube 102 to form the first radial seal 134 between the filter media 112 and the outer surface 105 of the inlet tube 102.

Next, the filter element 110 is straightened while it is moved downwardly in a direction toward the seal 172 in the sump tube sheet 168. The filter element 110 is oriented within the seat 172 to form the second radial seal 136 between the second end cap 126 and the sump tube sheet 168. If the filter element 110 also contains the outer region of filter media 140, the radial seal 166 is also formed between the outer filter support 146 and the sump tube sheet 168.

The above process can be repeated for each primary filter element 110 located within the housing 14.

Occasionally, the pre-filter arrangement 22 will also need servicing. This is done by removing the swarf basket 44 by grasping the handles 50. Next, the filter element 64 is removed by grasping the handles 81, 82. This releases the seal 86 between the element 64 and the plate 95. The swarf basket 44 is cleaned. A new filter element 64 is provided by orienteing the element 64 on the plate 95 and creating the seal 86 between the element 64 and the plate 95. The basket 44 is then placed over the element 64.

A method of separating a mist from a gas stream can be employed using the systems and structures described herein. First, a gas stream containing a mist is directed into the inlet 20 of the housing 14. The gas stream containing the mist is pre-filtered to remove at least some particulate and liquid. Specifically, the shield 56 in the basket 44 and the tangential inlet 20 causes the gas stream to flow in a centrifugal path. This centrifugal flow causes a certain amount of particulate to drop by gravity to the base 62 of the basket 44. Next, the gas stream flows through the pre-filter media 66 and into the open pre-filter interior 72. At least some liquid is coalesced from the gas stream by the pre-filter media. This liquid drains by gravity to the base 62 and flows through the drain 36, downwardly through the tubing 38 and to the sump arrangement 30, specifically the liquid collection arrangement 170.

Next, the gas stream is directed from the pre-filter interior 72, past the fan 96, through the interior 106 of inlet tube 102, and into the open filter interior 114 of the primary filter element 110. From there, the gas stream flows through at least one region of filter media 112 which removes further particular and coalesces more liquid from the gas stream. If there exists an additional layer of media, such as a high efficiency or HEPA media 140, the gas stream also flows through the outer region 140 after flowing through the inner region of media 112. The filtered fluid then exits the housing 14 by flowing through the outlet arrangement 32 located in the doors 19 of the lower chamber 18. Liquid that is coalesced by the primary filter element 110 drains by gravity to the sump tube sheet 168 and then drains by gravity through one of the drain holes 182, 192, 196 and into the liquid collection arrangement 170.

D. Inventive Concepts

A filter arrangement for a gas stream containing a mist includes a housing including an inlet, an interior, and an outlet arrangement; the inlet being oriented to receive a gas stream containing a mist; a pre-filter arrangement oriented to receive the gas stream containing the mist from the inlet; the pre-filter arrangement removing at least some particulate material from the gas stream and at least partially coalescing the mist into a liquid; at least one tubular primary filter element having at least one region of filter media and an open filter interior; the tubular primary filter element being operably oriented in the housing interior downstream of the pre-filter arrangement and oriented to receive flow of the gas stream into the open filter interior then through the at least one region of filter media and then exit the housing through the outlet arrangement; the tubular primary filter element at least partially coalescing the mist into liquid; and a liquid sump arrangement oriented in the housing constructed and arranged to collect liquid removed by the pre-filter arrangement and the primary filter element.

In example implementations: the pre-filter arrangement is oriented vertically above the at least one tubular primary filter element; the pre-filter arrangement includes a basket and a pre-filter element; the pre-filter element comprises a tubular region of pre-filter media and an open pre-filter interior; the tubular pre-filter element being operably oriented in the housing interior to receive the air stream flowing through the housing inlet, through the region of pre-filter media, and into the open pre-filter interior; and the tubular pre-filter element at least partially coalescing the mist into a liquid.

In example implementations: there is a fan operably oriented in the housing interior downstream of the tubular pre-filter element; there is drain structure oriented to collect liquid from the pre-filter arrangement, bypass the primary filter element, and direct the collected liquid to the sump arrangement; the primary filter element includes at least two regions of filter media; the pre-filter arrangement, primary filter element, and liquid sump arrangement are oriented in vertically stacked configuration; the primary filter element includes first and second opposite end caps; the at least one region of filter media being in extension between the first and second end caps; and the primary filter element has a length of at least 28 inches.

In example implementations: the primary filter element includes: a first inwardly directed radial seal between the first end cap and an inlet tube in the filter housing; and a second inwardly directed radial seal between the second end cap and a portion of the sump arrangement.

In example implementations: the primary filter element includes at least two regions of filter media; and the primary filter element includes an outwardly directed radial seal between the second cap and a portion of the sump arrangement; the first inwardly directed radial seal defines a first inner diameter; and the second inwardly directed radial seal defines a second inner diameter smaller than the first inner diameter; the at least one tubular primary filter element includes at least two tubular primary filter elements operably installed in the housing downstream of the pre-filter arrangement; the at least two tubular primary filter elements includes at least four tubular primary filter elements operably installed in the housing downstream of the pre-filter arrangement; and the outlet arrangement in the housing comprises a plurality of apertures defined by the housing adjacent to the primary filter element.

A filter element is provided including first and second end caps; an inner tubular region of filter media extending between the first and second end caps; an outer filter support circumscribing the inner tubular region of filter media and extending from the second end cap toward the first end cap; the outer filter support defining a filter seat at a location spaced from at least the second end cap; and an outer tubular region of filter media being positioned in the filter seat; the outer tubular region of media being radially spaced from the inner tubular region of filter media by a gap of at least 0.12 inch.

In example implementations: the outer tubular region of filter media is spaced from both the first end cap and second end cap; a first radial seal member at the first end cap; a second radial seal at the second end cap; the first end cap comprises a compressible foamed polyurethane forming the first radial seal member; and the second end cap comprises a compressible foamed polyurethane forming the second radial seal member.

In example implementations: the first radial seal member and the second radial seal member are inwardly directed; the filter element has a length of at least 28 inches; there is a third radial seal member oriented against the outer filter support; and the third radial seal member is outwardly directed.

In example implementations: a first radial seal member is at the first end cap; the first end cap comprises a compressible foamed polyurethane forming the first radial seal member; the first radial seal member is inwardly directed; a second radial seal is at the second end cap; the second end cap comprises a compressible foamed polyurethane forming the second radial seal member; the second radial seal member is inwardly directed; a third radial seal member is oriented against the outer filter support; the third radial seal member is outwardly directed; the inner tubular region of filter media comprises pleated media; and the outer tubular region of filter media comprises a high efficiency media.

A filter element is provided including first and second opposite ends defining a length therebetween; a first open end cap at the first end; the first end cap defining a first inwardly directed radial sealing portion; the first inwardly directed radial sealing portion defining a first end cap inner diameter; a second end cap at the second end; the second end cap defining a second inwardly directed radial sealing portion; the second inwardly directed radial sealing portion defining a second end cap inner diameter; the second end cap inner diameter being smaller than the first end cap inner diameter; a cylindrical region of pleated media extending between the first and second end caps; the cylindrical region having an inner diameter; and a ratio of the inner diameter of the cylindrical region of pleated media to the length is not greater than 0.3.

In example implementations: a ratio of the second end cap inner diameter to the first end cap inner diameter is at least 0.15; the pleated media has a pleat depth of 1.4-2 inches; the filter element has an overall length of 34-40 inches; the first inwardly directed radial sealing portion comprises a compressible polyurethane foam; and the second inwardly directed radial sealing portion comprises a compressible polyurethane foam;

A method of servicing is provided including accessing an interior to a housing; removing a first filter element from the housing; providing a second filter element; tilting the second filter element relative to the housing while placing the second filter element in the interior of the housing; while tilting, orienting a top end cap of the second filter element around an inlet flow tube in the housing to form a first radial seal between the second filter element and the inlet flow tube; and straightening the second filter element while moving the second filter element down to form a second radial seal between a second end cap in the second filter element and a portion of the housing.

In example implementations: the method includes while straightening the second filter element to form a second radial seal, forming a third radial seal between an outwardly extending radial seal member on the second filter element and a portion of the housing; the step of providing a second filter element includes providing a second filter element having an inner region of pleated media and an outer region of one of HEPA media or 95% DOP media; the step of accessing an interior includes opening a door in a sidewall of the housing.

A method of filtering includes directing a gas stream containing mist into an inlet of a housing and through pre-filter arrangement to remove some particulate material and coalesce at least some of the mist into liquid; directing the gas stream from the pre-filter arrangement and into at least one region of media in a primary filter to result in a filtered fluid; the at least one region of media coalescing the mist into liquid; directing the filtered fluid out of the housing; draining liquid from the pre-filter arrangement past the primary filter to a sump; and draining liquid from the primary filter to the sump.

In example implementations: the step of directing a gas stream containing mist into an inlet of a housing and through pre-filter arrangement includes directing the gas stream into a centrifugal separator, through filter media and into a pre-filter interior; the step of directing the gas stream from the pre-filter arrangement and into at least one region of media in a primary filter includes directing the gas stream from the pre-filter interior, past a fan, and through the at least one region of media of the primary filter; the step of directing the gas stream from the pre-filter arrangement and into at least one region of media in a primary filter to result in a filtered fluid includes directing the gas stream into an interior of a primary filter and then through the at least one region of media to result in filtered fluid; the step of directing the gas stream from the primary filter interior and through at least one region of media to result in a filtered fluid includes directing the gas stream from the primary filter interior through a region of pleated media and then through a region of high efficiency media; the step of directing the gas stream from the pre-filter interior, past a fan, and into an interior of a primary filter includes directing the mist into an interior of one of at least two primary filters; the step of directing the gas stream from the pre-filter interior, past a fan, and into an interior of a primary filter includes directing the gas stream into an interior of one of at least four primary filters.

A filter arrangement for a gas stream containing a mist includes a housing including an inlet, an interior, and an outlet arrangement; the inlet being oriented to receive a gas stream containing a mist; a pre-filter arrangement oriented to receive the gas stream containing the mist from the inlet; the pre-filter arrangement removing at least some particulate material from the gas stream and at least partially coalescing the mist into a liquid; at least one primary filter element operably oriented in the housing interior downstream of the pre-filter arrangement and oriented to receive flow of the gas stream to at least partially coalescing the mist into liquid; a liquid sump arrangement oriented in the housing constructed and arranged to collect liquid removed by the pre-filter arrangement and the primary filter element; and a pre-filter drain arrangement constructed and arranged to convey liquid from the pre-filter arrangement to the liquid sump arrangement while bypassing the at least one primary filter element.

In example implementations: the prefilter arrangement includes a basket and a pre-filter element; the basket includes a top plate defining an opening, a surrounding wall connected to the top plate; the surrounding wall including a solid shield and a porous inner liner; a base disc connected to the surrounding wall; and an outer liner connected to the base disc and generally parallel to the inner liner; the base disc defining drainage apertures therethrough; the drainage apertures being in fluid communication with the pre-filter drain arrangement; the pre-filter element being oriented within the opening in the top plate; the pre-filter element comprising a cylindrical arrangement of filter media; and the at least one primary filter element has a length of 34-40 inches.

A method of filtering is provides including directing a gas stream containing mist into an inlet of a housing and through a pre-filter arrangement to remove some particulate material and coalesce at least some of the mist into liquid; and then directing the gas stream in a direction downwardly from the prefilter arrangement and downwardly to a primary filter; directing the gas stream through at least one region of media in the primary filter to result in a filtered fluid; the at least one region of media coalescing the mist into liquid; directing the filtered fluid out of the housing; and draining liquid from the pre-filter arrangement and the primary filter.

Many embodiments of the invention can be made without departing from the spirit and scope of the invention.

1. A filter arrangement for a gas stream containing a mist; the filter arrangement comprising:
(a) a housing including an inlet, an interior, and an outlet arrangement; the inlet being oriented to receive a gas stream containing a mist;
(b) a pre-filter arrangement oriented to receive the gas stream containing the mist from the inlet; the pre-filter arrangement removing at least some particulate material from the gas stream and at least partially coalescing the mist into a liquid;
(c) at least one tubular primary filter element having at least one region of filter media and an open filter interior; the tubular primary filter element being operably oriented in the housing interior downstream of the pre-filter arrangement and oriented to receive flow of the gas stream into the open filter interior then through the at least one region of filter media and then exit the housing through the outlet arrangement;
(i) the tubular primary filter element at least partially coalescing the mist into liquid; and
(d) a liquid sump arrangement oriented in the housing constructed and arranged to collect liquid removed by the pre-filter arrangement and the primary filter element.

2. A filter arrangement according to claim 1 wherein:
(a) the pre-filter arrangement is oriented vertically above the at least one tubular primary filter element.

3. A filter arrangement according to claim 1 wherein:
(a) the pre-filter arrangement includes a basket and a pre-filter element.

4. A filter arrangement according to claim 3 wherein:
(a) the pre-filter element comprises a tubular region of pre-filter media and an open pre-filter interior; the tubular pre-filter element being operably oriented in the housing interior to receive the air stream flowing through the housing inlet, through the region of pre-filter media, and into the open pre-filter interior; and
(i) the tubular pre-filter element at least partially coalescing the mist into a liquid.

5. A filter arrangement according to claim 4 further comprising:
(a) a fan operably oriented in the housing interior downstream of the tubular pre-filter element.

6. A filter arrangement according to claim 1 further including:
(a) drain structure oriented to collect liquid from the pre-filter arrangement, bypass the primary filter element, and direct the collected liquid to the sump arrangement.

7. A filter arrangement according to claim 1 wherein:
(a) the primary filter element includes at least two regions of filter media.

8. A filter arrangement according to claim 1 wherein:
(a) the pre-filter arrangement, primary filter element, and liquid sump arrangement are oriented in vertically stacked configuration.

10. A filter arrangement according to claim 1 wherein:
(a) the primary filter element includes first and second opposite end caps; the at least one region of filter media being in extension between the first and second end caps; and
(b) the primary filter element has a length of at least 28 inches.

11. A filter arrangement according to claim 10 wherein:
(a) the primary filter element includes:
(i) a first inwardly directed radial seal between the first end cap and an inlet tube in the filter housing; and
(ii) a second inwardly directed radial seal between the second end cap and a portion of the sump arrangement.

12. A filter arrangement according to claim 11 wherein:
(a) the primary filter element includes at least two regions of filter media; and
(b) the primary filter element includes an outwardly directed radial seal between the second cap and a portion of the sump arrangement.

13. A filter arrangement according to claim 11 wherein:
(a) the first inwardly directed radial seal defines a first inner diameter; and
(b) the second inwardly directed radial seal defines a second inner diameter smaller than the first inner diameter.

14. A filter arrangement according to claim 1 wherein:
(a) the at least one tubular primary filter element includes at least two tubular primary filter elements operably installed in the housing downstream of the pre-filter arrangement.

15. A filter arrangement according to claim 14 wherein:
(a) the at least two tubular primary filter elements includes at least four tubular primary filter elements operably installed in the housing downstream of the pre-filter arrangement.

16. A filter arrangement according to claim 1 wherein:
(a) the outlet arrangement in the housing comprises a plurality of apertures defined by the housing adjacent to the primary filter element.

17. A filter element comprising:
(a) first and second end caps;
(b) an inner tubular region of filter media extending between the first and second end caps;
(c) an outer filter support circumscribing the inner tubular region of filter media and extending from the second end cap toward the first end cap;
(i) the outer filter support defining a filter seat at a location spaced from at least the second end cap; and
(d) an outer tubular region of filter media being positioned in the filter seat;
(i) the outer tubular region of media being radially spaced from the inner tubular region of filter media by a gap of at least 0.12 inch.

18. A filter element according to claim 17 wherein:
(a) the outer tubular region of filter media is spaced from both the first end cap and second end cap.

19. A filter element according to claim 17 further comprising:
(a) a first radial seal member at the first end cap; and
(b) a second radial seal at the second end cap.

20. A filter element according to claim 19 wherein:
(a) the first end cap comprises a compressible foamed polyurethane forming the first radial seal member; and
(b) the second end cap comprises a compressible foamed polyurethane forming the second radial seal member.

21. A filter element according to claim 17 wherein:
(a) the first radial seal member and the second radial seal member are inwardly directed; and
(b) the filter element has a length of at least 28 inches.

22. A filter element according to claim 19 further comprising:
(a) a third radial seal member oriented against the outer filter support.

23. A filter element according to claim 22 wherein:
(a) the third radial seal member is outwardly directed.

24. A filter element according to claim 18 further comprising:
(a) a first radial seal member at the first end cap;
(i) the first end cap comprises a compressible foamed polyurethane forming the first radial seal member;
(ii) the first radial seal member is inwardly directed;
(b) a second radial seal at the second end cap;
(i) the second end cap comprises a compressible foamed polyurethane forming the second radial seal member;
(ii) the second radial seal member is inwardly directed;
(c) a third radial seal member oriented against the outer filter support;
(i) the third radial seal member is outwardly directed;
(d) the inner tubular region of filter media comprises pleated media; and
(e) the outer tubular region of filter media comprises a high efficiency media.

25. A filter element comprising:
(a) first and second opposite ends defining a length therebetween;
(b) a first open end cap at the first end;
(i) the first end cap defining a first inwardly directed radial sealing portion; the first inwardly directed radial sealing portion defining a first end cap inner diameter;
(c) a second end cap at the second end;
(i) the second end cap defining a second inwardly directed radial sealing portion; the second inwardly directed radial sealing portion defining a second end cap inner diameter;
(A) the second end cap inner diameter being smaller than the first end cap inner diameter;
(d) a cylindrical region of pleated media extending between the first and second end caps; the cylindrical region having an inner diameter; and
(e) a ratio of the inner diameter of the cylindrical region of pleated media to the length is not greater than 0.3.

26. A filter element according to claim 25 wherein:
(a) a ratio of the second end cap inner diameter to the first end cap inner diameter is at least 0.15.

27. A filter element according to claim 26 wherein:
(a) the pleated media has a pleat depth of 1.4-2 inches; and
(b) the filter element has an overall length of 34-40 inches.

28. A filter element according to claim 27 wherein:
(a) the first inwardly directed radial sealing portion comprises a compressible polyurethane foam; and
(b) the second inwardly directed radial sealing portion comprises a compressible polyurethane foam;

29. A method of servicing a filter arrangement; the method comprising:
(a) accessing an interior to a housing;
(b) removing a first filter element from the housing;
(c) providing a second filter element;
(d) tilting the second filter element relative to the housing while placing the second filter element in the interior of the housing;
(e) while tilting, orienting a top end cap of the second filter element around an inlet flow tube in the housing to form a first radial seal between the second filter element and the inlet flow tube; and
(f) straightening the second filter element while moving the second filter element down to form a second radial seal between a second end cap in the second filter element and a portion of the housing.

30. A method of servicing according to claim 29 further comprising:
(a) while straightening the second filter element to form a second radial seal, forming a third radial seal between an outwardly extending radial seal member on the second filter element and a portion of the housing.

31. A method of servicing according to claim 30 wherein:
(a) the step of providing a second filter element includes providing a second filter element having an inner region of pleated media and an outer region of one of HEPA media or 95% DOP media.

32. A method of servicing according to claim 29 wherein:
(a) the step of accessing an interior includes opening a door in a sidewall of the housing.

33. A method of filtering a gas stream containing a mist; the method comprising:
(a) directing a gas stream containing mist into an inlet of a housing and through a pre-filter arrangement to remove some particulate material and coalesce at least some of the mist into liquid;
(b) directing the gas stream from the pre-filter arrangement and into at least one region of media in a primary filter to result in a filtered fluid;
(i) the at least one region of media coalescing the mist into liquid;
(d) directing the filtered fluid out of the housing;
(e) draining liquid from the pre-filter arrangement to bypass the primary filter to a sump; and
(f) draining liquid from the primary filter to the sump.

34. A method according to claim 33 wherein:
(a) the step of directing a gas stream containing mist into an inlet of a housing and through pre-filter arrangement includes directing the gas stream into a centrifugal separator, through filter media and into a pre-filter interior; and
(b) the step of directing the gas stream from the pre-filter arrangement and into at least one region of media in a primary filter includes directing the gas stream from the pre-filter interior, past a fan, and through the at least one region of media of the primary filter.

35. A method according to claim 33 wherein:
(a) the step of directing the gas stream from the pre-filter arrangement and into at least one region of media in a primary filter to result in a filtered fluid includes directing the gas stream into an interior of a primary filter and then through the at least one region of media to result in filtered fluid.

36. A method according to claim 35 wherein:
(a) the step of directing the gas stream from the primary filter interior and through at least one region of media to result in a filtered fluid includes directing the gas stream from the primary filter interior through a region of pleated media and then through a region of high efficiency media.

37. A method according to claim 34 wherein:
(a) the step of directing the gas stream from the pre-filter interior, past a fan, and into an interior of a primary filter includes directing the mist into an interior of one of at least two primary filters.

38. A method according to claim 37 wherein:
(a) the step of directing the gas stream from the pre-filter interior, past a fan, and into an interior of a primary filter includes directing the gas stream into an interior of one of at least four primary filters.

39. A filter arrangement for a gas stream containing a mist; the filter arrangement comprising:
(a) a housing including an inlet, an interior, and an outlet arrangement; the inlet being oriented to receive a gas stream containing a mist;
(b) a pre-filter arrangement oriented to receive the gas stream containing the mist from the inlet; the pre-filter arrangement removing at least some particulate material from the gas stream and at least partially coalescing the mist into a liquid;
(c) at least one primary filter element operably oriented in the housing interior downstream of the pre-filter arrangement and oriented to receive flow of the gas stream to at least partially coalescing the mist into liquid;
(d) a liquid sump arrangement oriented in the housing constructed and arranged to collect liquid removed by the pre-filter arrangement and the primary filter element; and
(e) a pre-filter drain arrangement constructed and arranged to convey liquid from the pre-filter arrangement to the liquid sump arrangement while bypassing the at least one primary filter element.

40. A filter arrangement according to claim 39 wherein:
(a) the prefilter arrangement includes a basket and a pre-filter element;
(i) the basket includes a top plate defining an opening, a surrounding wall connected to the top plate; the surrounding wall including a solid shield and a porous inner liner; a base disc connected to the surrounding wall; and an outer liner connected to the base disc and generally parallel to the inner liner;
(A) the base disc defining drainage apertures therethrough;
(B) the drainage apertures being in fluid communication with the pre-filter drain arrangement; and
(ii) the pre-filter element being oriented within the opening in the top plate; the pre-filter element comprising a cylindrical arrangement of filter media.

41. A filter arrangement according to claim 39 wherein:
(a) the at least one primary filter element has a length of 34-40 inches.

42. A method of filtering a gas stream containing a mist; the method comprising:
(a) directing a gas stream containing mist into an inlet of a housing and through a pre-filter arrangement to remove some particulate material and coalesce at least some of the mist into liquid; and then
(b) directing the gas stream in a direction downwardly to a primary filter;
(c) directing the gas stream through at least one region of media in the primary filter to result in a filtered fluid;
(i) the at least one region of media coalescing the mist into liquid;
(d) directing the filtered fluid out of the housing;
(e) and draining liquid from the pre-filter arrangement and the primary filter.
